(19) United States
(12) Patent Application Publication
(10) Pub. No.: US 2004/0163717 A1
(43) Pub. Date: Aug. 26, 2004

(54) MEMS device assembly

(75) Inventor: Kenneth B. Gilleo, Cranston, RI (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Cookson Electronics, Inc.

(21) Appl. No.: 10/371,452

(22) Filed: Feb. 21, 2003

(51) Int. Cl. G05D 7/06

(52) U.S. Cl. 137/565.29

(57) ABSTRACT

An assembly of the present invention has a substrate and a first MEMS device adapted to be electrically and mechanically connected to the substrate. A first set of MEMS/substrate fluid transfer ports on the first MEMS device and on the substrate are adapted to mate with one another when the first MEMS device and substrate are connected to permit the transfer of fluid between the first MEMS device and the substrate.

### BACKGROUND OF THE INVENTION

The present invention relates generally to a MEMS device assembly, and more particularly to an assembly that permits the transfer of fluid between the device and a substrate.

MEMS, or Micro-Electro-Mechanical Systems, are integrated circuit devices that have moving microscopic parts that perform all of the functions of large machinery such as motors, pumps, turbines, and gas sensors. MEMS devices are typically affixed to a circuit substrate such as a package, chip carrier or circuit board via conventional microchip attachment means. Multi-chip modules typically include multiple MEMS devices mounted on a common substrate that can cooperate to convey, receive, or analyze fluid (i.e., liquid or gas). In some applications a powder or particulate material is entrained in the fluid and conveyed to a cooperating MEMS device on the substrate. Reference may be made to U.S. Pat. No. 6,471,853, incorporated by reference herein for all purposes, for additional background information relating to fluid conveying MEMS devices and multi-chip modules.

Typical MEMS devices include heat sensitive parts that are easily damage by the use of soldering or other thermal bonding processes included in conventional chip attachment methods such as Direct Chip Attachment or wire bonding. Reference may be made to U.S. Pat. Nos. 5,120,678 and 5,439,162, both of which are incorporated by reference herein for all purposes, for additional background information relating to Direct Chip Attachment processes requiring thermal bonding. Existing electromechanical connection methods that eliminate thermal bonding processes allow a conventional microchip device to be electrically and mechanically mounted on a substrate of the circuit so that the chip can be removed and reconnected without heating the chip or the substrate. These conventional electro-mechanical connection methods typically include metallized interlocking structures (i.e., hook and loop configurations, locking inserts and sockets, interlocking micromechanical barbs) located on the electrical connection pads (i.e., bond pads) of the microchip and the substrate. Reference may be made to U.S. Pat. Nos. 5,411,400, 5,774,341, and 5,903,059, which are incorporated by reference herein for all purposes, for additional background information relating to reconnectable electro-mechanical connections between an electronic device and a substrate. Existing reconnectable microchip mounting structures do not include connection structures to accommodate MEMS devices that convey fluid between other devices in the circuit.

With existing chip attachment methods, fluid interchange between MEMS devices is effected through open channels in the top surface of the substrate on which the MEMS devices are attached or through complicated micro-tubing assemblies on the surface of the substrate. Open channels in the substrate do not provide sufficient enclosure to contain many types of fluids that are conveyed between MEMS devices, and the channels are not easily aligned with the MEMS devices after testing and reattachment. Also, micro-tubing assemblies on the surface of the substrate are expensive to fabricate and assemble and do not allow for easy reassembly and testing of the MEMS device.

### SUMMARY OF THE INVENTION

Among the several objects of this invention may be noted the provision of a MEMS device assembly which allows fluid communication between adjacent MEMS devices mounted on a substrate; the provision of such an assembly which allows fluid communication between MEMS devices mounted on adjacent substrates; the provision of such an assembly which allows fluid communication between attached MEMS devices; the provision of such an assembly which permits simple testing; the provision of such an assembly which allows easy rework; the provision of such an assembly that allows an enclosed path for fluid conveyance between MEMS devices; and the provision of such an assembly that allows easy removal and replacement of the MEMS device.

In general, an assembly of the present invention comprises a substrate and a first MEMS device adapted to be electrically and mechanically connected to the substrate. A first set of MEMS/substrate fluid transfer ports on the first MEMS device and on the substrate are adapted to mate with one another when the first MEMS device and substrate are connected to permit the transfer of fluid between the first MEMS device and the substrate.

In another aspect of the invention, the assembly comprises a substrate and first and second MEMS devices adapted for electrical and mechanical connection to the substrate. A first fluid transfer port is on the first MEMS device for conveying fluid from the first MEMS device and a second fluid transfer port is on the second MEMS device for conveying fluid to the second MEMS device. A fluid channel in the substrate is in fluid communication with the first and second fluid transfer ports of respective MEMS devices whereby fluid may be transferred via the fluid channel and the first and second fluid transfer ports from the first MEMS device to the second MEMS device.

In yet another aspect of the present invention, the assembly comprises a first substrate and a second substrate. A first MEMS device is adapted for electrical and mechanical connection to the first substrate. A second MEMS device is adapted for electrical and mechanical connection to the second substrate. A first set of MEMS/substrate fluid transfer ports on the first MEMS device and on the first substrate are adapted to mate with one another when the first MEMS device and the first substrate are connected to permit the transfer of fluid between the first MEMS device and the first substrate. A first set of MEMS/substrate fluid transfer ports on the second MEMS device and on the second substrate are adapted to mate with one another when the second MEMS device and the second substrate are connected to permit the transfer of fluid between the second MEMS device and the second substrate. A fluid channel in the first substrate is in fluid communication with the first set of MEMS/substrate fluid transfer ports on the first MEMS device and the first substrate. A fluid channel in the second substrate is in fluid communication with the first set of MEMS/substrate fluid transfer ports on the second MEMS device and the second substrate. A first set of substrate/substrate fluid transfer ports on the first substrate and the second substrate are adapted to mate with one another to permit the transfer of fluid between respective fluid channels in the first and second substrates so that fluid may be transferred between the first MEMS device and the second MEMS device.

The present invention also includes a method of operating an integrated circuit of the type comprising a substrate, a first MEMS device adapted for electrical and mechanical connection to the substrate, and a first set of MEMS/substrate fluid transfer ports on the first MEMS device and the substrate adapted to mate with one another. The method comprises the steps of electrically and mechanically connecting the first MEMS device and the substrate in a position where the MEMS/substrate fluid transfer ports mate to permit the transfer of fluid between the MEMS device and the substrate. Fluid is transferred between the MEMS device and the substrate by passing the fluid through a channel in the substrate.

Other objects and features will be in part apparent and in part pointed out hereinafter.

### BRIEF DESCRIPTION OF THE DRAWINGS

FIG. 1 is an elevation, partially in section, of a multi-chip module showing a first embodiment of an assembly of the present invention, portions of the module being broken away to show details.

FIG. 2 is an exploded front elevation of certain parts of the module of the first embodiment.

FIG. 3 is a perspective of the module shown in FIG. 1, but without a protective cap.

FIG. 4 is an exploded perspective of various parts of the module.

FIG. 5 is a sectional view of two adjacent multi-chip modules showing a second embodiment of an assembly of the present invention, portions of the module being broken away to show details.

FIG. 6 is a sectional view of a multi-chip module showing a third embodiment of the assembly.

FIG. 7 is an exploded front perspective of the third embodiment.

FIG. 7A is an exploded rear perspective of certain components of the third embodiment.

FIG. 8 is an elevation, partially in section, of a multi-chip module showing a fourth embodiment of the assembly.

Corresponding parts are designated by corresponding reference numbers throughout the drawings.

### DETAILED DESCRIPTION OF PREFERRED EMBODIMENTS

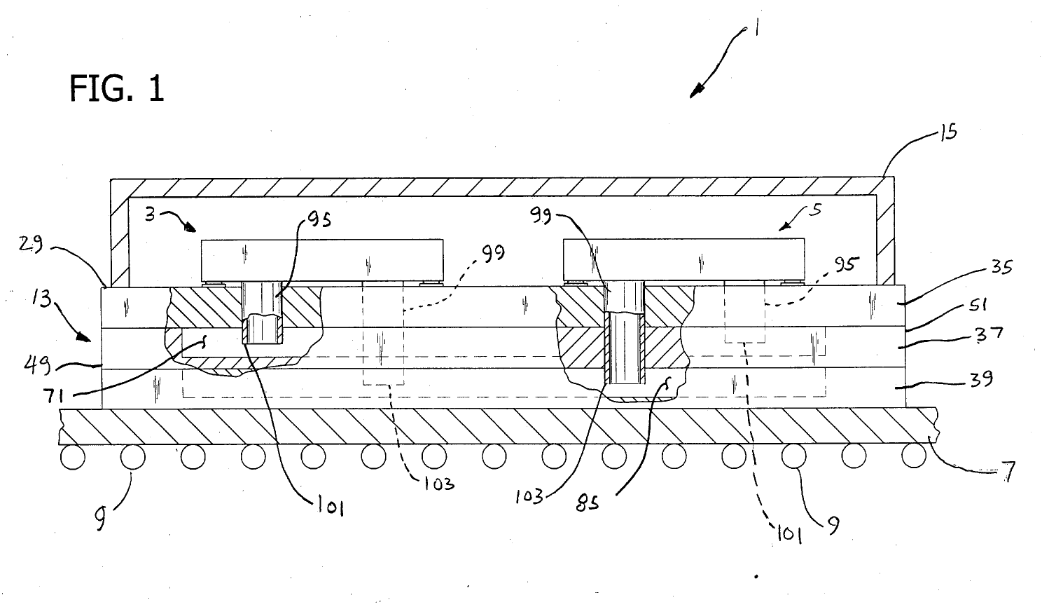

Referring now to the drawings, and more particularly to FIG. 1, a multi-chip module, generally designated 1, comprises two MEMS devices, generally designated 3 and 5, assembled in accordance with the present invention. In the particular embodiment of FIG. 1, the multi-chip module 1 is affixed to a conventional ball grid array 7 having solder balls 9 for electrical connection to a printed circuit board (not shown). It will be understood that the multi-chip module 1 could be directly attached to the circuit board or could be attached via other conventional connecting substrates (e.g., a pin-grid array or a land grid array).

As shown in FIGS. 1-4, the two MEMS devices 3, 5 of the multi-chip module 1 are electrically and mechanically attached to a chip carrier substrate generally designated 13. In the illustrated embodiments, each MEMS device 3, 5 is shown schematically but it will be understood that each device could comprise any typical integrated circuit device that conveys or receives fluid (e.g., pump, turbine, flow meter, gas sensor, etc.). The multi-chip module 1 of the present invention includes a protective cap 15 made from conventional materials (i.e., metal, ceramic, or plastic) that is affixed to the chip carrier substrate 13 by conventional means (i.e., welding, soldering, brazing) to enclose and protect each MEMS device 3, 5. Alternatively, the cap 15 of the multi-chip module 1 could have an access window (not shown) to allow light to pass through the cap, or the module could be supplied without a cap without departing from the scope of the present invention.

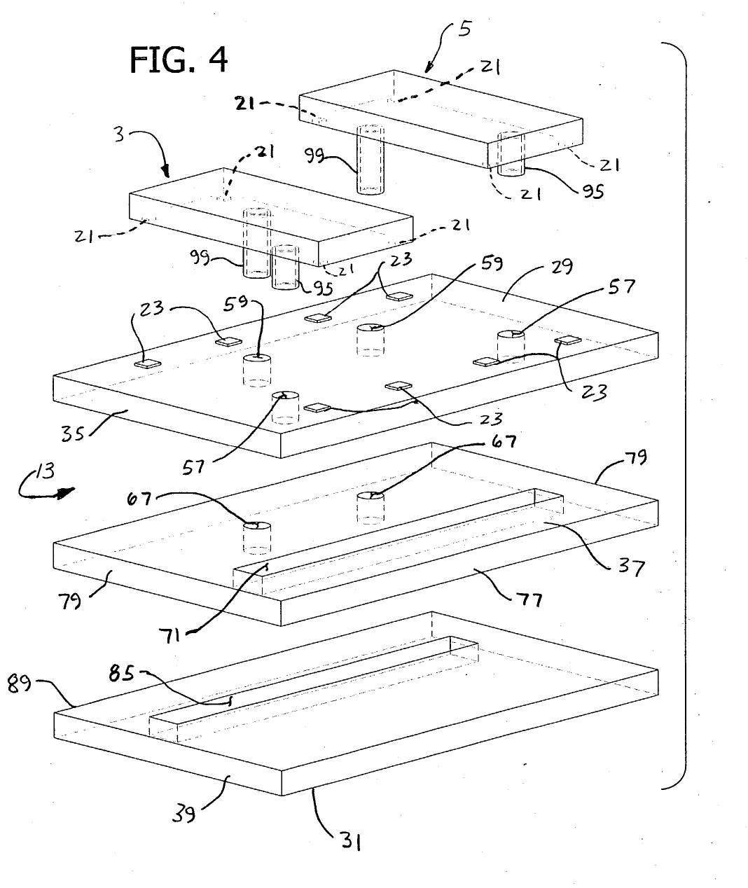

As shown in FIG. 4, each of the two MEMS devices 3, 5 has four electrical connection pads (i.e. bond pads) 21 for mating with corresponding electrical connection pads 23 on the chip carrier substrate 13. Preferably, each connection pad 21 on the MEMS device 3, 5 and each pad 23 on the substrate 13 includes cooperating connecting elements that are capable of electrically and mechanically connecting the MEMS device to the chip carrier substrate. The MEMS/substrate cooperating connecting elements could be any type of conventional interlocking connecting elements know in the art (i.e., hook and loop configurations, locking inserts and sockets, interlocking micromechanical barbs, etc.) that would allow each MEMS device 3, 5 to be easily removed and reconnected to the chip carrier substrate 13. Alternatively, the MEMS device 3, 5 may be mounted on the substrate 13 by conventional chip attachment means such as wire bonding or direct chip attachment (i.e., flip chip).

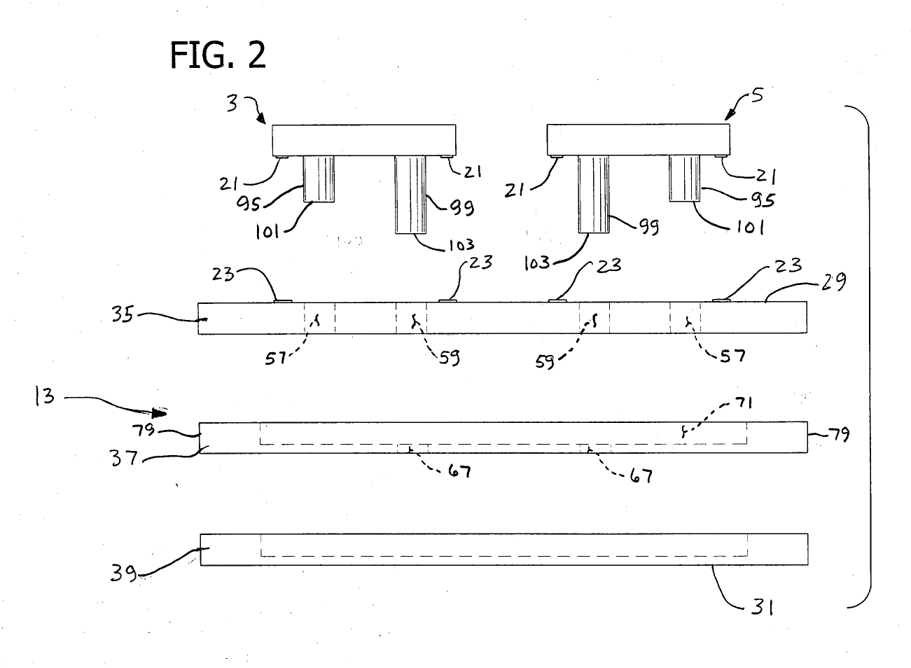

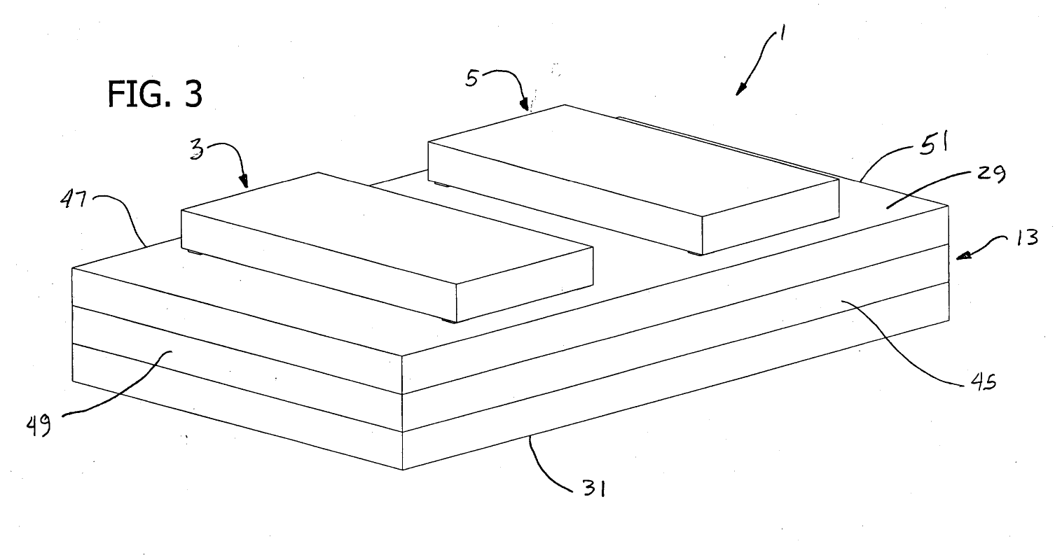

As seen in FIGS. 2 and 3, the chip carrier substrate 13 of the illustrated embodiment is a rectangular substrate having a top surface 29 for receiving the two MEMS devices 3, 5 and a bottom surface 31 for connection to the ball-grid array 7 (FIG. 1). In the illustrated embodiment, the substrate 13 is a laminate comprising a top layer 35, a middle layer 37, and a bottom layer 39 that are held together by conventional means such as an adhesive or thermal bonding. It will be understood that each layer of the substrate 13 could comprise silicon, ceramic, or any other suitable semi-conductor material. In the illustrated embodiments the substrate 13 comprises three layers, but one, two, or more than three layers could be provided without departing from the scope of this invention. Also, the layers of the substrate 13 are shown as having approximately equal thicknesses but it will be understood that the substrate could include layers of varying thickness without departing from the scope of this invention. As shown in FIG. 3, the substrate 13 has distinct front and rear edge surfaces, 45 and 47 respectively, and opposite side surfaces 49, 51. It will be understood that the substrate 13 could have other sizes and shapes without departing from the scope of this invention.

As best shown in FIG. 4, the top layer 35 of the substrate 13 has two groups of connection pads 23, each group including four pads. The pads 23 protrude from the top surface 29 of the substrate 13 and are located for mating with respective electrical connection pads 21 on the first and second MEMS devices 3, 5. The top layer 35 also has two pairs of first (front) ports 57 and second (rear) ports 59 (e.g., openings or holes) that pass completely through the top layer 35 of the substrate 13. As shown in FIG. 4, the first pair of ports is located on the substrate 13 at a position directly below the first MEMS device 3 and the second pair of ports is located on the substrate at a position directly below the second MEMS device 5. In the illustrated embodiment, each port 57, 59 has a circular cross section but it will be understood that the ports could have other shapes and sizes without departing from the scope of the invention.

Referring again to FIG. 4, the middle layer 37 of the chip carrier substrate 13 has two ports (e.g., openings or holes) 67 similar in size and shape to the ports 57, 59 of the first layer 35 and passing entirely through the middle layer. The ports 67 of the middle layer 37 have a circular cross section and are axially aligned with the rear ports 59 on the top layer 35 to form a continuous passage from the top layer through the middle layer of the substrate 13. The middle layer 37 has an elongate channel 71 in the upper surface spaced forward from the ports 67 and located inward from the front edge surface 77 and opposed side edge surfaces 79 of the middle layer. The channel 71 has a depth less than the thickness of the middle layer 37 and a length sufficient to allow fluid communication between the front ports 57 of the top layer 35. It will be understood that the channel 71 can have other shapes and sizes without departing from the scope of this invention. As seen in FIG. 1, the channel 71 in the middle layer 37 of the substrate 13 is substantially enclosed by the top layer 35 of the substrate so that fluid is contained and allowed to pass between the front ports 57 in the top layer.

As seen in FIG. 4, the bottom layer 39 of the laminated chip carrier substrate 13 of this particular embodiment is similar in size and shape to the first two layers 35, 37 and has an elongate channel 85 spaced in from the rear edge surface 89 of the bottom layer. The rear channel 85 in the bottom layer 39 is similar in size and shape as the front channel 71 in the middle layer 37 and has a depth less than the thickness of the bottom layer. The rear channel 85 has a length sufficient to allow fluid communication between the two middle layer ports 67 that are axially aligned with the respective rear ports 59 of the top layer 35. As seen in FIG. 1, the channel 85 in the bottom layer 39 of the substrate 13 is enclosed by the middle layer 37 of the substrate so that fluid in the channel is contained and allowed to pass between the ports 67 of the middle layer.

In the illustrated embodiment, the ports and channels of each layer of the substrate 13 are formed by micro-machining each individual layer before assembling the layers to form the laminated chip carrier substrate. Alternatively, the formation of these elements can be achieved by chemical etching or other processes. Each layer of the substrate 13 may be silicon, ceramic or any suitable material that may be micro-machined and configured for receiving a MEMS device 3, 5 of the electronic circuit.

As shown in FIGS. 2 and 4, each MEMS device 3, 5 has a first port comprising a front tubular conduit 95 and a second port comprising a rear tubular conduit 99 extending from the device. In one embodiment, each conduit 95, 99 is generally an open ended tube made from the same semi-conductor material as the MEMS device 3, 5 (i.e. silicon, ceramic, or any other suitable semi-conductor material). Each conduit 95, 99 is formed integral with the MEMS device 3, 5 as part of the MEMS fabrication process and extends from the device to a free distal end 101, 103 to allow for the transfer of fluid to and from the MEMS device. In the illustrated embodiment, each MEMS device 3, 5 is shown schematically but it will be understood that each device may be any typical MEMS device that conveys or receives a fluid (i.e., liquid or gas) or a particulate or nanopowder entrained in the fluid. It will be understood that the tubular conduits 95, 99 can be fabricated using conventional MEMS fabrication processes such as microelectronic photolithographic techniques (i.e., LIGA processes) or other well-known processes such as surface micromachining and etching. Alternatively, each conduit 95, 99 may be made of a metal or metal alloy (e.g., copper or copper alloys) and fabricated from conventional microfabrication processes such as electroplating or sputtering to form a tube or other hollow appendage extending from the MEMS device 3, 5.

As seen in FIGS. 1 and 2, the front tubular conduits 95 are shorter than the rear tubular conduits 99 of each device 3, 5, but it will be understood that the conduits may have other lengths and configurations without departing from the scope of this invention. The front tubular conduit 95 of each device 3, 5 is sized and located to mate with the corresponding front port 57 on the top layer 35 of the chip carrier substrate 13. The rear tubular conduit 99 of each device 3, 5 is sized to mate with the corresponding rear port 59 on the top layer 35 of the substrate 13. Each front and rear conduit 95, 99 on the MEMS device 3, 5 is adapted for a sealing fit in a respective port 57, 59 on the substrate 13 so that fluid may be conveyed through the port. It will be understood that this seal may be accomplished in various ways without departing from the scope of this invention. In the preferred embodiment, each mating conduit 95, 99 and port 57, 59 may be sized for an interference fit with the conduit having a tapered outer surface to provide a tighter seal between the conduit and its respective port.

The mating conduits 95, 99 and ports 57, 59 between the MEMS devices 3, 5 and the substrate 13 establish a reconnectable MEMS/substrate connection that allows fluid communication between the first and second MEMS devices via the substrate. As shown in FIG. 1, the front conduit 95 of each MEMS device 3, 5 extends through the top layer 35 of the substrate 13 and into the front channel 71 of the middle layer 37 of the substrate to allow fluid communication between each MEMS device and the channel. The rear tubular conduit 99 of each MEMS device 3, 5 is received in a respective rear port 59 of the top layer 35 of the substrate 13 and extends through the port 67 of the middle layer 37 into the rear channel 85 of the bottom layer 39 of the substrate to allow fluid communication between the MEMS device and the channel. The type of fluid exchanged through the channels 71, 85 depends on the type and purpose of the MEMS devices 3, 5 being used in the electronic circuit. Exemplary fluids include water, air or other gas, and the fluid may contain nanopowder or other particulate to be conveyed through the substrate 13.

In one exemplary embodiment, the front tubular conduit 95 of each MEMS device 3, 5 may have a length of approximately 150 microns and a tapered outer surface having a maximum diameter of approximately 75 microns. The rear tubular conduit 99 of each MEMS device 3, 5 may have a length of approximately 250 microns and a tapered outer surface maximum diameter of approximately 75 microns. Each opening 57, 59 in the substrate 13 for receiving a corresponding tubular conduit 95, 99 may be sized with a diameter of approximately 70 microns to provide a tight sealing fit between the opening and the conduit. Each layer of the substrate 13 may have a thickness of approximately 100 microns, a width of approximately 1.0 mm, and a length of approximately 2.0 mm. Each channel 71, 85 may have a depth of approximately 75 microns, a width of approximately 100 microns and a length of approximately 1.8 mm. It will be understood that the components described above can have other dimensions and can be otherwise arranged without departing from the scope of this invention.

In operation, an integrated circuit including an assembly 1 of the present invention is operated by electrically and mechanically connecting the first and second MEMS devices 3, 5 to the chip carrier substrate 13 so that the first and second fluid transfer ports 95, 99 mate with respective front and rear transfer ports 57, 59 on the substrate. The chip carrier substrate 13 is configured to receive electrical signals from a printed circuit board (not shown) or other components of an electronic circuit. As seen in FIG. 1, fluid from the first MEMS device 3 is conveyed through the front conduit 95 to the forward channel 71 in the second layer 37 of the substrate 13. Upon receiving an electrical current from the chip carrier substrate 13, the second MEMS device 5 is activated to effect the transfer of fluid between the device and the substrate. In one embodiment, fluid in the forward channel 71 in the substrate 13 is conveyed to the second MEMS device 5 through the front conduit 95 on the second device. It will be understood that fluid from the second MEMS device 5 can be conveyed to the first MEMS device 3 in a similar operation via the rear channel 85 in the substrate 13 and the rear conduits 99 on respective MEMS devices. Also, each MEMS device 3, 5 could be configured so that fluid flow through the forward channel 71 and/or rear channel 85 is reversed without departing from the scope of this invention. The method of operation of the present invention could include liquid or gas as the fluid medium and also could include a particulate or nanopowder entrained in the fluid.

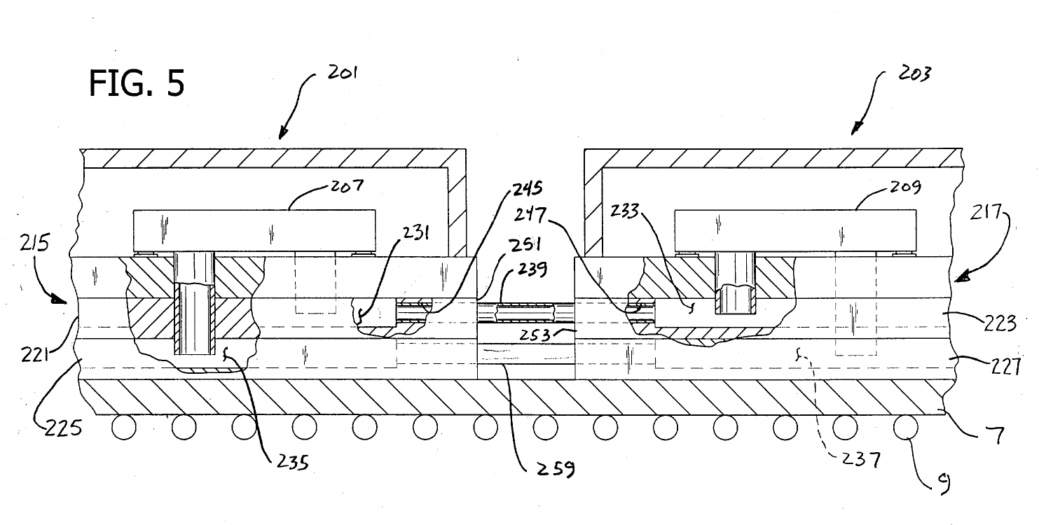

FIG. 5 illustrates adjacent multi-chip modules, generally designated 201 and 203, assembled in accordance with a second embodiment of the present invention. The two multi-chip modules 201, 203 of this embodiment are each substantially similar to the multi-chip module 1 of the first embodiment. Each module 201, 203 is illustrated as having one MEMS device 207, 209 mounted on a respective chip carrier substrate, generally designated 215 and 217, but it will be understood that each module could have two or more MEMS devices as in the previous embodiment. Each chip carrier substrate 215, 217 is similar to the three-layer laminated substrate 13 of the first embodiment but is configured to allow fluid exchange between respective MEMS devices 207, 209 located on adjacent multi-chip modules 201, 203 in an electrical circuit.

As shown in FIG. 5, the substrate 215, 217 of each module has a middle layer 221, 223 and a bottom layer 225, 227 configured with corresponding substrate/substrate mating ports that allow fluid to be transferred between respective front channels 231, 233 and rear channels 235, 237 in each substrate. The substrate/substrate mating ports of the middle layer 221, 223 of each substrate 215, 217 comprise an upper (first) tubular conduit 239 in communication with the front channel 231 of the first substrate 215 and the front channel 233 of the second substrate 217 to allow fluid transfer between the two MEMS devices 207, 209. The conduit 239 is sealingly secured in bores 245, 247 (e.g., openings or holes) extending laterally inward from adjacent side edges 251, 253 of the middle layers 221, 223 to respective front channels 231, 233. The bottom layer 225, 227 has substrate/substrate mating ports that comprise a lower tubular conduit 259 substantially similar to the upper conduit 239 but configured to allow fluid transfer between the rear channels 235, 237 of the first and second substrates 215, 217.

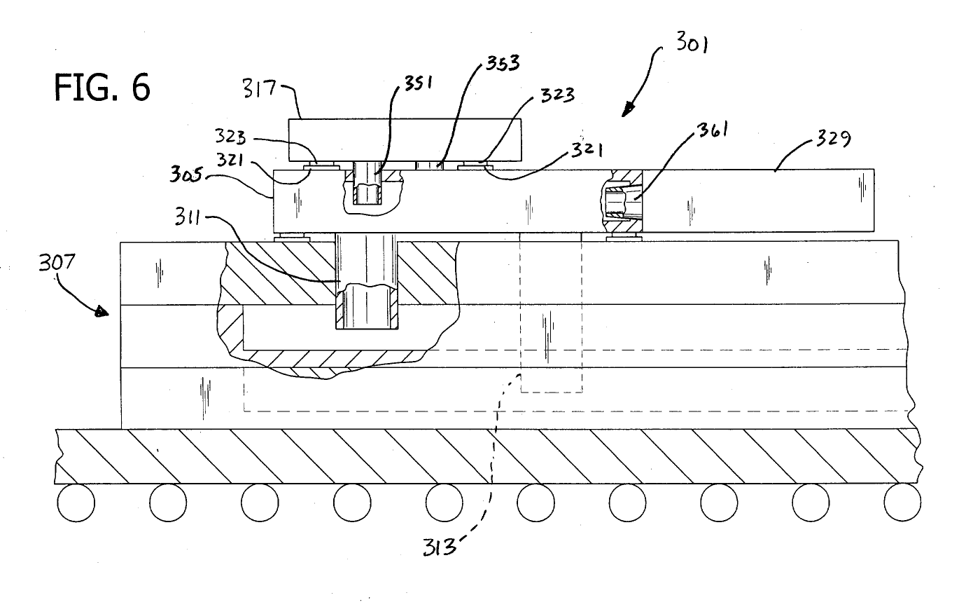

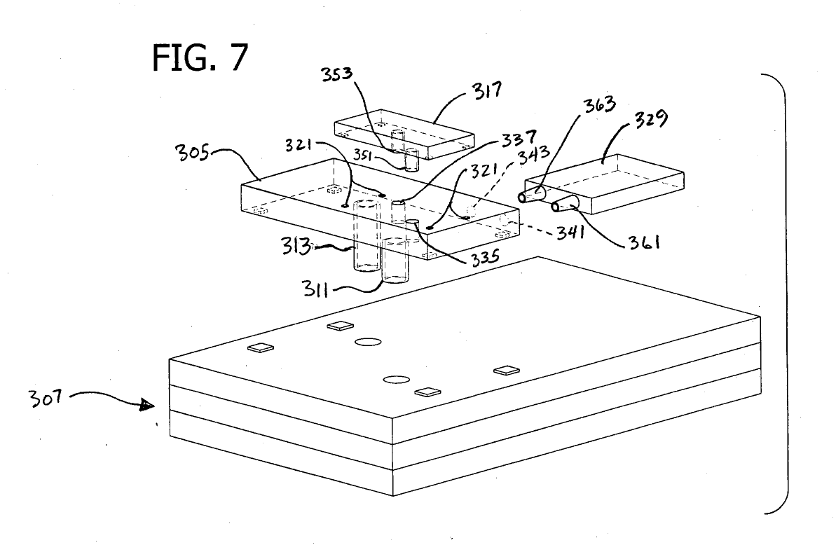

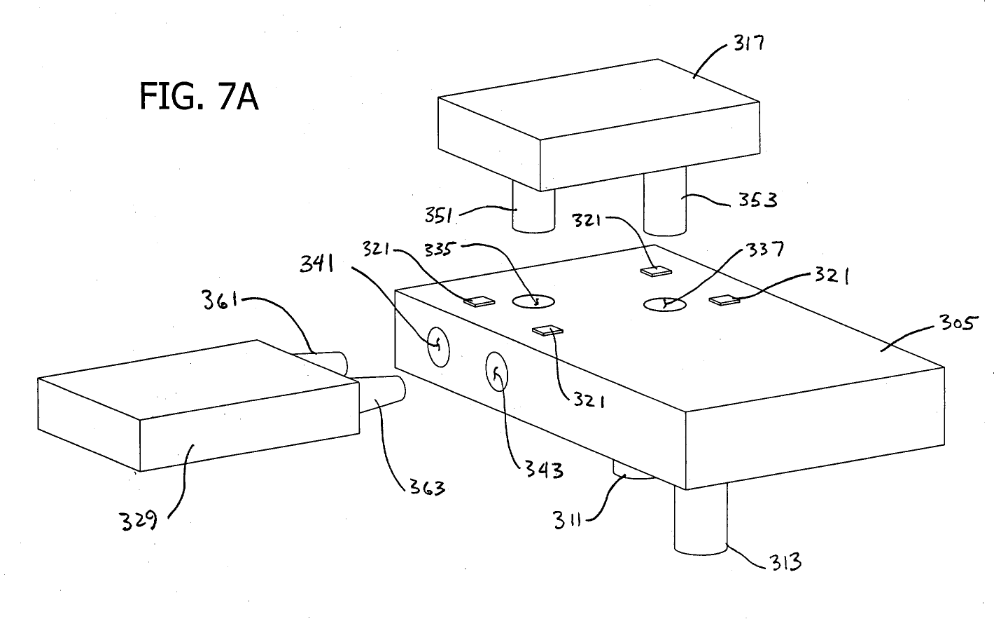

FIGS. 6-7A illustrate a multi-chip module 301 assembled in accordance with a third embodiment of the present invention. The multi-chip module 301 of this embodiment includes a first MEMS device 305 attached to a laminated chip carrier substrate 307 substantially similar to the chip carrier substrate 13 of the first embodiment and having a front tubular conduit 311 and a rear tubular conduit 313 as in the previous embodiments. The multi-chip module 301 of this embodiment includes a second MEMS device 317 electrically and mechanically attached to the top of the first MEMS device 305. It will be understood that the first and second MEMS devices 305, 317 can be configured to have cooperating electrical connection elements on the bond pads 321, 323 of the respective devices to allow the second device to be physically and electrically attached to the first device. As in the previous embodiments, the first and second MEMS devices 305, 317 of this embodiment could be any typical MEMS device that conveys or receives fluids. In the embodiment shown in FIGS. 6-7A, a third MEMS device 329 is attached to the side of the first MEMS device 305 and functions as a reservoir to add additional fluid volume to the first MEMS device. Alternatively, the third MEMS device 329 may be configured as a heater for raising the temperature or causing a chemical reaction of the fluid and/or particulate conveyed by the first MEMS device. Also, the third MEMS 329 device could be a pump or turbine that boosts the pressure of the fluid conveyed through the substrate 307 by the first MEMS device 305.

As seen in FIGS. 7 and 7A, the first MEMS 305 device has front and rear top ports 335, 337 (e.g., openings or holes) on the top surface of the device and front and rear side ports 341, 343 on the side of the device. The second MEMS device 317 has a first (front) port 351 comprising a front tubular conduit and a second (rear) port 353 comprising a rear tubular conduit extending from the device. Each conduit 351, 353 of the second MEMS device 317 is sized to be received in a respective front or rear top port 335, 337 in the top surface of the first MEMS device 305 to allow fluid communication between the first and second MEMS devices. The third MEMS device 329 has front and rear ports comprising respective tubular conduits 361, 363 extending from the third device. Each conduit 361, 363 of the third MEMS device 329 is sized to be received in a respective front or rear side port 341, 343 of the first MEMS device 305 to allow fluid communication between the first and third MEMS devices. In one embodiment, each tubular conduit 361, 363 of the third MEMS device 329 has a tapered outer surface that provide an interference fit with a respective side port 341, 343 of the first MEMS device 305 to allow a tight sealing fit and a secure mechanical attachment with the first device. It will be understood that the second and third MEMS devices, 317 and 329 respectively, may also be held in contact with the first MEMS device 305 by surface attractive forces (e.g., stiction forces) that are common in microchip connections.

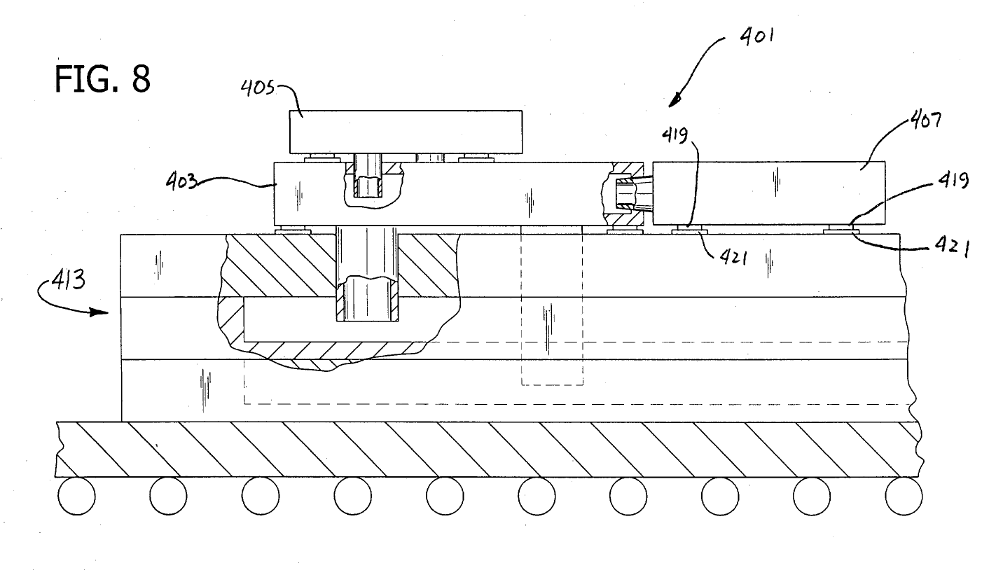

FIG. 8 illustrates a multi-chip module 401 assembled in accordance with a fourth embodiment of the present invention. This embodiment 401 is substantially similar to the third embodiment 301 in that the first MEMS device 403 has a second and third MEMS device 405, 407 attached thereto. The third MEMS device 407 of this embodiment 401 is similar to the first two MEMS devices 403, 405 in that the third device also is electrically and mechanically attached to the substrate 413 at a location directly adjacent the connection of the first MEMS device to the substrate. The third MEMS device 407 has connection pads 419 that are electrically and mechanically connected with corresponding connection pads 421 on the substrate 413 in a manner similar to that described in the previous embodiments. It will be understood that the third MEMS device 407 of this embodiment 401 may include any typical MEMS device that is electrically connected to the electronic circuit to convey or receive fluid.

In view of the above, it will be seen that the several objects of the invention are achieved and other advantageous results attained. For example, the configuration of the present invention with mating MEMS/substrate fluid transfer ports in communication with fluid channels in the substrate 13 allows for fluid communication between adjacent MEMS devices 3, 5. The mating MEMS/substrate fluid transfer ports allow the MEMS devices 3, 5 to be easily removed and reattached to the substrate 13 without requiring extensive rework to accommodate the fluid transfer connections of the MEMS device. The configuration of the laminated substrate 13 with internal channels below the surface of the substrate allows for an enclosed path for fluid conveyance between MEMS devices 3, 5 mounted on the same substrate. Also, the mating substrate/substrate fluid transfer ports of FIG. 5 allow fluid communication between MEMS devices 207, 209 mounted on adjacent substrates 215, 217. The mating MEMS/MEMS fluid transfer ports of FIGS. 6-7A allow fluid communication between attached MEMS devices 305, 317, 329.

As various changes could be made in the above constructions without departing from the scope of the invention, it is intended that all matter contained in the above description or shown in the accompanying drawings shall be interpreted as illustrative and not in a limiting sense. For example, the MEMS/substrate and substrate/substrate mating ports could have other shapes and sizes to allow an easily reconnectable connection that allows fluid conveyance through the ports. Also, the channels in the substrate(s) could have other sizes and shapes so as to maintain fluid communication with respective ports of the substrate(s). Furthermore, the MEMS devices of the present invention could be configured to send or receive optoelectronic signals without departing from the scope of this invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

What is claimed is:

1. An assembly comprising
a substrate,
a first MEMS device adapted to be electrically and mechanically connected to the substrate, and
a first set of MEMS/substrate fluid transfer ports on the first MEMS device and on the substrate adapted to mate with one another when the first MEMS device and substrate are connected to permit the transfer of fluid between the first MEMS device and the substrate.

2. An assembly as set forth in claim 1 further comprising a first set of cooperating MEMS/substrate connecting elements on the first MEMS device and on the substrate for electrically and mechanically connecting the first MEMS device and the substrate.

3. An assembly as set forth in claim 1 wherein said first set of MEMS/substrate fluid transfer ports comprises a conduit on one of the first MEMS device and the substrate and an opening in the other of the first MEMS device and the substrate for receiving said conduit.

4. An assembly as set forth in claim 3 wherein said conduit comprises a tube extending from the first MEMS device receivable in said opening in the substrate.

5. An assembly as set forth in claim 1 wherein said substrate has a first fluid channel therein providing fluid communication between said first set of MEMS/substrate fluid transfer ports and a fluid transfer port of a different MEMS device.

6. An assembly as set forth in claim 5 wherein said substrate is a laminate comprising a first layer having at least one fluid transfer port of said first set of MEMS/substrate fluid transfer ports, and a second layer having said first fluid channel therein.

7. An assembly as set forth in claim 6 further comprising a second set of MEMS/substrate fluid transfer ports on the first MEMS device and the substrate adapted to mate with one another when the first MEMS device and substrate are connected to permit the transfer of fluid between the first MEMS device and the substrate.

8. An assembly as set forth in claim 7 wherein said laminate comprises a third layer having a second fluid channel therein providing fluid communication between said second set of MEMS/substrate fluid transfer ports and a fluid transfer port of a different MEMS device.

9. An assembly as set forth in claim 1 further comprising
a second MEMS device adapted to be electrically and mechanically connected to the substrate,
a first set of MEMS/substrate fluid transfer ports on the second MEMS device and the substrate adapted to mate with one another when the second MEMS device and substrate are connected to permit the transfer of fluid between the second MEMS device and the substrate, and
a first fluid channel in the substrate providing fluid communication between the first set of mating MEMS/substrate fluid transfer ports of the first MEMS device and the substrate and the first set of mating MEMS/substrate fluid transfer ports of the second MEMS device and the substrate.

10. An assembly as set forth in claim 9 further comprising a second set of MEMS/substrate fluid transfer ports on the first MEMS device and the substrate adapted to mate with one another when the first MEMS device and substrate are connected to permit the transfer of fluid between the first MEMS device and the substrate.

11. An assembly as set forth in claim 10 further comprising a second set of MEMS/substrate fluid transfer ports on the second MEMS device and the substrate adapted to mate with one another when the second MEMS device and substrate are connected to permit the transfer of fluid between the second MEMS device and the substrate.

12. An assembly as set forth in claim 11 further comprising a second fluid channel in the substrate providing fluid communication between the second set of mating MEMS/substrate fluid transfer ports of the first MEMS device and the substrate and the second set of mating MEMS/substrate fluid transfer ports of the second MEMS device and the substrate.

13. An assembly as set forth in claim 12 wherein said substrate is a laminate comprising a first layer having a fluid transfer port of each of said first and second sets of MEMS/substrate fluid transfer ports, a second layer having said first fluid channel therein, and a third layer having said second fluid channel therein.

14. An assembly as set forth in claim 1 further comprising
a second MEMS device adapted to be connected to the first MEMS device,
a first set of MEMS/MEMS fluid transfer ports on the first MEMS device and the second MEMS device adapted to mate with one another when the first and second MEMS devices are connected to permit the transfer of fluid between the first and second MEMS devices.

15. An assembly as set forth in claim 14 further comprising a first set of cooperating MEMS/substrate connecting elements on the first MEMS device and the substrate for electrically and mechanically connecting the first MEMS device to the substrate.

16. An assembly as set forth in claim 15 further comprising a first set of cooperating MEMS/MEMS connecting elements on the first MEMS device and the second MEMS device for electrically and mechanically connecting the first and second MEMS devices.

17. An assembly as set forth in claim 15 further comprising a first set of MEMS/substrate cooperating connecting elements on the second MEMS device and the substrate for electrically and mechanically connecting the second MEMS device to the substrate.

18. An assembly as set forth in claim 14 wherein said first set of MEMS/MEMS fluid transfer ports comprises a conduit on one of the first and second MEMS devices and an opening in the other of the first and second MEMS devices.

19. An assembly as set forth in claim 18 wherein said conduit comprises a tube extending from the second MEMS device receivable in said opening in the first MEMS device.

20. An assembly as set forth in claim 18 wherein said tube is sized for an interference fit with the opening in the first MEMS device.

21. An assembly as set forth in claim 1 wherein said substrate comprises at least one layer of silicon, and wherein at least one fluid transfer port of said first set of fluid transfer ports comprises an opening micro-machined in said silicon layer.

22. An assembly as set forth in claim 1 wherein said substrate comprises at least one layer of ceramic, and wherein at least one fluid transfer port of said first set of fluid transfer ports comprises an opening micro-machined in said ceramic layer.

23. An assembly as set forth in claim 1 wherein said first set of MEMS/substrate fluid transfer ports is adapted for the transfer of gas.

24. An assembly as set forth in claim 1 wherein said first set of MEMS/substrate fluid transfer ports is adapted for the transfer of liquid.

25. An assembly as set forth in claim 1 wherein said first set of MEMS/substrate fluid transfer ports is adapted for the transfer of particulate material entrained in a fluid.

26. An assembly comprising
a substrate,
first and second MEMS devices adapted for electrical and mechanical connection to the substrate,
a first fluid transfer port on the first MEMS device for conveying fluid from the first MEMS device,
a second fluid transfer port on the second MEMS device for conveying fluid to the second MEMS device,
a fluid channel in the substrate in fluid communication with the first and second fluid transfer ports of respective MEMS devices whereby fluid may be transferred via said fluid channel and said fluid transfer ports from the first MEMS device to the second MEMS device.

27. An assembly as set forth in claim 26 further comprising cooperating MEMS/substrate connecting elements for electrically and mechanically connecting the first and second MEMS devices to the substrate

28. An assembly as set forth in claim 26 wherein each of said fluid transfer ports comprises a conduit extending from a respective MEMS device.

29. An assembly as set forth in claim 28 wherein said conduit comprises a tube extending from one MEMS device receivable in an opening in the substrate.

30. An assembly as set forth in claim 26 wherein said fluid channel is adapted for the transfer of gas.

31. An assembly as set forth in claim 26 wherein said fluid channel is adapted for the transfer of liquid.

32. An assembly as set forth in claim 26 wherein said fluid channel is adapted for the transfer of particulate material entrained in a fluid.

33. An assembly comprising
a first substrate,
a second substrate,
a first MEMS device adapted for electrical and mechanical connection to the first substrate,
a second MEMS device adapted for electrical and mechanical connection to the second substrate,
a first set of MEMS/substrate fluid transfer ports on the first MEMS device and on the first substrate adapted to mate with one another when the first MEMS device and the first substrate are connected to permit the transfer of fluid between the first MEMS device and the first substrate,
a first set of MEMS/substrate fluid transfer ports on the second MEMS device and on the second substrate adapted to mate with one another when the second MEMS device and the second substrate are connected to permit the transfer of fluid between the second MEMS device and the second substrate,
a fluid channel in the first substrate in fluid communication with said first set of MEMS/substrate fluid transfer ports on the first MEMS device and the first substrate,
a fluid channel in the second substrate in fluid communication with said first set of MEMS/substrate fluid transfer ports on the second MEMS device and the second substrate,
a first set of substrate/substrate fluid transfer ports on the first substrate and the second substrate adapted to mate with one another to permit the transfer of fluid between respective fluid channels in the first and second substrates so that fluid may be transferred between the first MEMS device and the second MEMS device.

34. An assembly as set forth in claim 33 wherein each of said first set of MEMS/substrate fluid transfer ports on the first MEMS device and the first substrate comprises a conduit on one of the first MEMS device and the first substrate and an opening in the other of the first MEMS device and the first substrate, and wherein each of said first set of MEMS/substrate fluid transfer ports on the second MEMS device comprises a conduit on one of the second MEMS device and the second substrate and an opening in the other of the second MEMS device and the second substrate.

35. An assembly as set forth in claim 34 wherein each of said conduits comprises a tube extending from a respective MEMS device receivable in an opening in a respective substrate.

36. An assembly as set forth in claim 33 wherein said first set of substrate/substrate fluid transfer ports on the first substrate and the second substrate comprises a conduit on one of the first substrate and the second substrate and an opening in the other of the first substrate and the second substrate.

37. An assembly as set forth in claim 36 wherein said conduit comprise a tube extending from the first substrate receivable in said opening in the second substrate.

38. A method for operating an integrated circuit of the type comprising a substrate, a first MEMS device adapted for electrical and mechanical connection to the substrate, and a first set of MEMS/substrate fluid transfer ports on the first MEMS device and the substrate adapted to mate with one another, said method comprising the steps of
electrically and mechanically connecting the first MEMS device and the substrate in a position where the MEMS/substrate fluid transfer ports mate to permit the transfer of fluid between the MEMS device and the substrate,
transferring fluid between the MEMS device and the substrate, said transferring step comprising passing the fluid through a channel in the substrate.

39. A method as set forth in claim 38 wherein said transferring step comprises transferring gas through the channel in the substrate.

40. A method as set forth in claim 38 wherein said transferring step comprises transferring liquid through the channel in the substrate.

41. A method as set forth in claim 38 wherein said transferring step comprises transferring particulate material entrained in a fluid.
